(19) United States
(12) Patent Application Publication
(10) Pub. No.: US 2026/0101928 A1
(43) Pub. Date: Apr. 16, 2026

(54) INDUCTIVE HEATING

(71) Applicant: NICOVENTURES TRADING LIMITED, London (GB)

(72) Inventor: Anton Korus, Derby (GB)

(21) Appl. No.: 18/684,409

(22) PCT Filed: Aug. 30, 2022
(86) PCT No.: PCT/GB2022/052210

§ 371 Date: Feb. 16, 2024

(30) Foreign Application Priority Data
Aug. 31, 2021 (GB) 2112365.8

(51) Int. Cl. A24F 40/465

(52) U.S. Cl. CPC A24F 40/465

(57) ABSTRACT

An apparatus is described comprising a resonant circuit and a circuit for applying one or more pulses to said resonant circuit. The resonant circuit comprises an inductive element and a capacitor. The inductive element comprises one or more coils that are at least partially exposed, wherein said inductive element is for heating a susceptor when said susceptor is placed across, and makes electrical contact with, said exposed coils.

### TECHNICAL FIELD

The present specification relates to an inductive heating arrangement for use in aerosol generating devices. The aerosol generating devices may be tobacco heating products, for example.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol generating substrate such as tobacco to form an aerosol by heating, but not burning, the substrate. The material may, for example, be tobacco or other non-tobacco products, which may or may not contain nicotine.

### SUMMARY

In a first aspect, this specification describes an apparatus comprising: a resonant circuit comprising an inductive element and a capacitor, wherein the inductive element comprises one or more coils that are at least partially exposed, wherein said inductive element is for heating a susceptor when said susceptor is placed across, and makes electrical contact with, said exposed coils; and a circuit (e.g. a driving circuit or a control circuit) for applying one or more pulses to said resonant circuit. The said coils may be gold or gold tipped.

The exposed coils of the inductive element may be resistant to corrosion.

The one or more coils of the inductive element may be formed by a printed circuit board. For example, the printed circuit board may be a multi-layer printed circuit board and said coils may be formed from different layers of said printed circuit board.

The inductive element may comprise an electrically-conductive non-spiral first portion coincident with a first plane, an electrically-conductive non-spiral second portion coincident with a second plane that is spaced from the first plane, and an electrically-conductive connector that electrically connects the first portion to the second portion. The first portion may be a first partial annulus and the second portion may be a second partial annulus.

In some example embodiments, the inductive element and the capacitor are connected in parallel. In some example embodiments, the inductive element and the capacitor are connected in series.

The circuit may be a self-oscillating driving circuit. Alternatively, said circuit includes an H-bridge driving circuit.

In a second aspect, this specification describes a delivery system comprising an apparatus as described above with reference to the first aspect. The delivery system may be a non-combustible aerosol generating device

The delivery system may be configured to receive a removable article comprising an aerosol generating material. For example, the aerosol generating device of the delivery system may be configured to receive the removable article in such a way that the susceptor makes physical contact with the exposed parts of the one or more coils (such that the susceptor and the coil(s) are in electrical contact). The aerosol generating material may, for example, comprise an aerosol generating substrate and an aerosol forming material. The removable article may include a susceptor arrangement.

Furthermore, in use, the susceptor arrangement may make electrical contact with the one or more at least partially exposed coils of the inductive element of the apparatus.

### BRIEF DESCRIPTION OF THE DRAWINGS

Example embodiments will now be described, by way of example only, with reference to the following schematic drawings, in which:

FIG. 1 is a block diagram of a system in accordance with an example embodiment;

FIG. 2 is a block diagram of a circuit in accordance with an example embodiment;

FIG. 3 is a cross-sectional view of an inductor arrangement in accordance with an example embodiment;

FIG. 4 is a perspective view of an inductor in accordance with an example embodiment;

FIG. 5 is a plan view of an inductor arrangement in accordance with an example embodiment;

FIG. 6 shows an equivalent inductor circuit in accordance with an example embodiment;

FIG. 7 is a side view of an aerosol provision system in accordance with an example embodiment;

FIG. 8 is a block diagram of a system in accordance with an example embodiment;

FIG. 9 is a block diagram of a circuit in accordance with an example embodiment; and

FIG. 10 is a block diagram of a circuit in accordance with an example embodiment.

### DETAILED DESCRIPTION

As used herein, the term “aerosol delivery device” is intended to encompass systems that deliver a substance to a user, and includes:
non-combustible aerosol provision systems that release compounds from an aerosolisable material without combusting the aerosolisable material, such as electronic cigarettes, tobacco heating products, and hybrid systems to generate aerosol using a combination of aerosolisable materials; and
articles comprising aerosolisable material and configured to be used in one of these non-combustible aerosol provision systems.

According to the present disclosure, a “combustible” aerosol provision system is one where a constituent aerosolisable material of the aerosol provision system (or component thereof) is combusted or burned in order to facilitate delivery to a user.

According to the present disclosure, a “non-combustible” aerosol provision system is one where a constituent aerosolisable material of the aerosol provision system (or component thereof) is not combusted or burned in order to facilitate delivery to a user. In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolisable material is not a requirement.

In some embodiments, the non-combustible aerosol provision system is an aerosol-generating material heating system, also known as a heat-not-burn system. An example of such a system is a tobacco heating system.

In one embodiment, the non-combustible aerosol provision system is a hybrid system to generate aerosol using a combination of aerosolisable materials, one or a plurality of which may be heated. Each of the aerosolisable materials may be, for example, in the form of a solid, liquid or gel and may or may not contain nicotine. In one embodiment, the hybrid system comprises a liquid or gel aerosolisable material and a solid aerosolisable material. The solid aerosolisable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energised so as to distribute power in the form of heat to an aerosolisable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolisable material, an aerosol generating component, an aerosol generating area, a mouthpiece, and/or an area for receiving aerosolisable material.

In one embodiment, the aerosol generating component is a heater capable of interacting with the aerosolisable material so as to release one or more volatiles from the aerosolisable material to form an aerosol.

In one embodiment, the aerosolisable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolisable material in order to achieve a physiological response other than olfactory perception. The active substance as used herein may be a physiologically active material, which is a material intended to achieve or enhance a physiological response.

The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, Cannabis or another botanical. In one embodiment, the active substance is a legally permissible recreational drug.

In some embodiments, the active substance comprises nicotine. In some embodiments, the active substance comprises caffeine, melatonin or vitamin B12. The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavours, carriers, pH regulators, stabilizers, and/or antioxidants.

In one embodiment, the article for use with the non-combustible aerosol provision device may comprise aerosolisable material or an area for receiving aerosolisable material. In one embodiment, the article for use with the non-combustible aerosol provision device may comprise a mouthpiece. The area for receiving aerosolisable material may be a storage area for storing aerosolisable material. For example, the storage area may be a reservoir. In one embodiment, the area for receiving aerosolisable material may be separate from, or combined with, an aerosol generating area.

Aerosolisable material, which also may be referred to herein as aerosol generating material, is material that is capable of generating aerosol, for example when heated, irradiated or energized in any other way. Aerosolisable material may, for example, be in the form of a solid, liquid or gel which may or may not contain nicotine and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosolisable material may be present on a substrate. The substrate may, for example, be or comprise paper, card, paperboard, cardboard, reconstituted aerosolisable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material or a material heatable by electrical conduction, or a susceptor.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

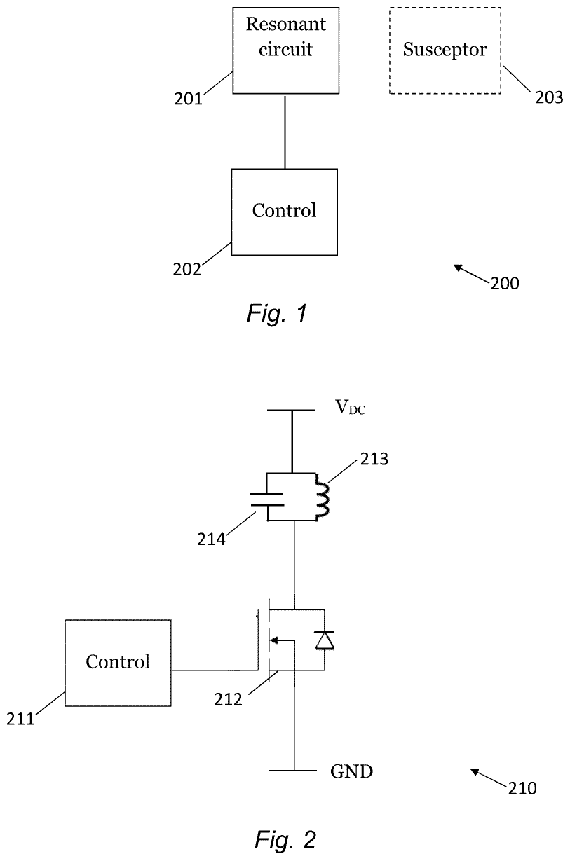

FIG. 1 is a block diagram of a system, indicated generally by the reference numeral 200, in accordance with an example embodiment. The system 200 comprises a resonant circuit 201 (e.g. an LC resonant circuit), a control module 202 and a susceptor 203. The resonant circuit 201 may be a self-oscillating driving circuit.

The resonant circuit 201 may comprise an inductor and a capacitor connected in series or in parallel. The resonant circuit may be used for inductively heating the susceptor 203 to heat an aerosol generating material. Heating the aerosol generating material may thereby generate an aerosol (as discussed further below).

The control module 202 provides a control signal (e.g. a driving signal) for the resonant circuit 201. For example, the control module 202 may provide a switching signal that switches between a first state and a second state that respectively charge and discharge the inductor of the resonant circuit 201. In such a configuration, the resonant circuit will resonate, with charge flowing from the inductor to the capacitor and back again.

Other arrangements for driving and controlling the resonant circuit are possible, as discussed further below.

The system 200 can be used with a wide variety of susceptor arrangements. Some embodiments are discussed below by way of example. However, the person of ordinary skill in the art will appreciate that other embodiments are possible.

A susceptor is a material that is heatable by penetration with a varying magnetic field, such as an alternating magnetic field. The heating material may be an electrically-conductive material, so that penetration thereof with a varying magnetic field causes inductive heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

FIG. 2 is a block diagram of a circuit, indicated generally by the reference numeral 210, in accordance with an example embodiment. The circuit 210 is an example implementation of the system 200 described above.

The circuit 210 comprises a control module 211, a transistor 212, an inductor 213 and a capacitor 214. The control module 211 and the transistor 212 are an example implementation of the control module 202 of the system 200. The parallel connection of the inductor 213 and the capacitor 214 are an example implementation of the resonant circuit 201. Thus, the resonant circuit formed of the inductor 213 and the capacitor 214 can be used for inductively heating the susceptor 203 of the system 200.

The transistor 212 has a first state and a second state dependent on the output of the control module 211. In the first state, the transistor 212 is conducting such that a varying current generated from a voltage supply V_{DC} flows through the inductor 213 (thereby charging the inductor). The voltage supply may be provided by a battery (e.g. a battery of an aerosol generating device).

In the second state, the first switching arrangement is non-conducting, such that the inductor 213 (which has been charged in the first state) discharges, thereby charging the capacitor 214. If the switching arrangement stayed in the second state, the resonant circuit 211 would resonate at a frequency dependent on the inductance (L) and capacitance (C) of the inductor 213 and the capacitor 214, given by the formula:

$$f = \frac{1}{2 π LC} .$$

Thus, the circuit 210 may, in some configurations, be a self-oscillating driving circuit.

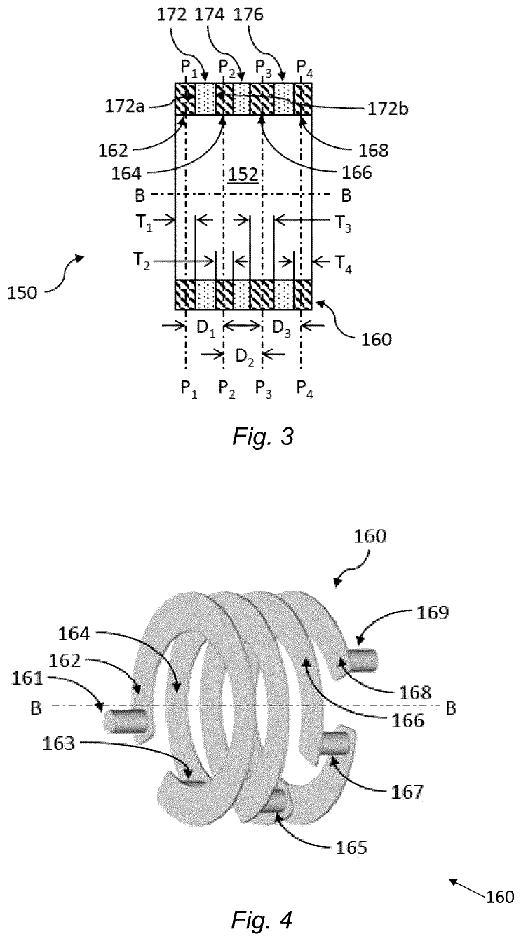

FIG. 3 is a cross-sectional view of an inductor arrangement, indicated generally by the reference numeral 150, in accordance with an example embodiment.

FIG. 4 is a perspective view of an inductor 160 of the inductor arrangement 150. The inductor 160 may be used to implement the inductor 213 of the resonant circuit described above (or inductors of other example embodiments described above), although alternative inductor arrangements may be used.

The inductor arrangement 150 comprises an electrically-insulating support 172 and the inductor 160. The support 172 has opposite first and second sides 172a, 172b, and parts 162, 164 of the inductor 160 are on the respective first and second sides 172a, 172b of the support 172.

More specifically, the inductor 160 is formed of an electrically-conductive element 160. The element 160 comprises an electrically-conductive non-spiral first portion 162 that is coincident with a first plane P₁, and an electrically-conductive non-spiral second portion 164 that is coincident with a second plane P₂ that is spaced from the first plane P₁. In this example, the second plane P₂ is parallel to the first plane P₁, but in other examples this need not be the case. For example, the second plane P₂ may be at an angle to the first plane P₁, such as an angle of no more than 20 degrees or no more than degrees or no more than 5 degrees. The inductor 160 also comprises a first electrically-conductive connector 163 that electrically connects the first portion 162 to the second portion 164. The first portion 162 is on the first side 172a of the support 172, and the second portion 164 is on the second side 172b of the support 172. The electrically conductive connector 163 passes through the support 172 from the first side 172a to the second side 172b. The electrically conductive connector 163 may have the structure of plating (e.g., copper plating) on the surface of a through hole provided in the support 172.

The support 172 can be made of any suitable electrically-insulating material(s). In some examples, the support 172 comprises a matrix (such as an epoxy resin, optionally with added filler such as ceramics) and a reinforcement structure (such as a woven or non-woven material, such as glass fibres or paper).

The inductor 160 can be made of any suitable electrically-conductive material(s). In some examples, the inductor 160 is made of copper.

In some examples, the inductor arrangement 150 comprises, or is formed from, a printed circuit board (PCB). In such examples, the support 172 is a non-electrically-conductive substrate of the PCB, which may be formed from materials such as FR-4 glass epoxy or cotton paper impregnated with phenolic resin, and the first and second portions 162, 164 of the inductor 160 are tracks on the substrate. This facilitates manufacture of the inductor arrangement 150, and also enables the portions 162, 164 of the element 160 to be thin and closely spaced, as discussed in more detail below.

In this example, the first portion 162 is a first partial annulus 162 and the second portion 164 is a second partial annulus 164. Moreover, in this example, each of the first and second portions 162, 164 follows only part of a respective circular path. Therefore, the first portion or first partial annulus 162 is a first circular arc, and the second portion or second partial annulus 164 is a second circular arc. In other examples, the first and second portions 162, 164 may follow a path that is other than circular, such as elliptical, polygonal or irregular.

As may best be understood from further consideration of FIG. 3, when viewed in a direction orthogonal to the first plane P₁, and thus in the direction of an axis B-B of the inductor 160, the first and second portions 162, 164 extend in opposite senses of rotation from the first electrically-conductive connector 163. For example, were one to view the inductor 160 of FIG. 3 in the direction of the axis B-B from left to right as FIG. 4 is drawn, then the first portion 162 of the inductor 160 would extend in an anticlockwise direction from the connector 163, whereas the second portion 164 of the inductor 160 would extend in a clockwise direction from the connector 163.

Moreover, in this example, when viewed in the direction orthogonal to the first plane P₁, the first portion 162 or first partial annulus overlaps, albeit only partially, the second portion 164 or second partial annulus. In this example, the first and second portions 162, 164 together define about 1.75 turns about the axis B-B that is orthogonal to the first and second planes P₁, P₂. In other examples, the number of turns may be other than 1.75, such as another number that is at least 0.9. For example, the number of turns may be between 0.9 and 1.5, or between 1 and 1.25. In other examples, the number of turns may be less than 0.9, although decreasing the number of turns per support 172 may lead to an increase in the axial length of the inductor assembly 150.

Furthermore, when viewed in the direction orthogonal to the first plane P₁, the first portion 162 or first partial annulus, as well as the second portion 164 or second partial annulus, at least partially overlaps the first electrically-conductive connector 163. This is facilitated by the inductor arrangement 150 comprising, or being formed from, a PCB (or more generally, a planar substrate layer). In particular, in such examples, the first electrically-conductive connector 163 takes the form of a “via” that extends through the support 172. Even in examples in which the inductor arrangement 150 is not formed from a PCB, the connector 163 still may extend through the support 172. This overlapped arrangement enables the inductor 160 to occupy a relatively small footprint, when viewed in the direction orthogonal to the first plane P₁, as compared to a comparative example in which the first and second portions 162, 164 are connected by a connector 163 that is spaced radially outwards of the first and second portions 162, 164. Furthermore, this overlapped arrangement enables the width of the through-hole 152 to be increased, as compared to a comparative example in which the first and second portions 162, 164 are connected by a connector 163 that is spaced radially inwards of the first and second portions 162, 164. Nevertheless, in some examples, the connector 163 may be radially-inward or radially-outward of the first and second portions 162, 164. This may be effected by the connector 163 being formed by a “through via” that extends through the support 172. Through vias tend to be cheaper to form than blind vias, as they can be formed after the PCB has been manufactured.

It will be noted that, in this example, the inductor arrangement 150 comprises two further supports 174, 176, and the element 160 comprises two further electrically-conductive non-spiral portions 166, 168 that are coincident with two respective spaced-apart planes P₃, P₄ that are parallel to the first plane P₁. In other examples, one or each of the spaced-apart planes P₃, P₄ may be at an angle to the first plane P₁, such as an angle of no more than 20 degrees or no more than 10 degrees or no more than 5 degrees. The second and third electrically-conductive non-spiral portions 164, 166 are on opposite sides of the second support 174, and are electrically connected by a second electrically-conductive connector 165. The third and fourth electrically-conductive non-spiral portions 166, 168 are on opposite sides of the third support 176, and are electrically connected by a third electrically-conductive connector 167. The second and third electrically-conductive connectors 165, 167 are rotationally offset from the first electrically-conductive connector 163. In arrangements in which the supports 172, 174 and 176 are formed as a PCB, the connectors 163 and 167 may be formed as “blind vias”, while connector 165 may be formed as a “buried via”.

It will be noted that the inductor 160 also comprises first and second terminals 161, 169 at opposite ends of the inductor 160. These terminals are for the passage of electrical current through the inductor 160 in use.

In this example, each of the planes P₁-P₄ is a flat plane, or a substantially flat plane. However, this need not be the case in other examples.

The combination of the first electrically-conductive connector 163 and the first and second portions 162, 164 of the electrically-conductive element 160 can be considered to be, or to approximate, a helical coil. Indeed, the full inductor 160 can be considered to be, or to approximate, a helical coil.

While the inductor arrangement 150 of the example shown in the Figures has three supports 172, 174, 176 and an inductor 160 comprising four portions 162, 164, 166, 168, this need not be the case in other example embodiments.

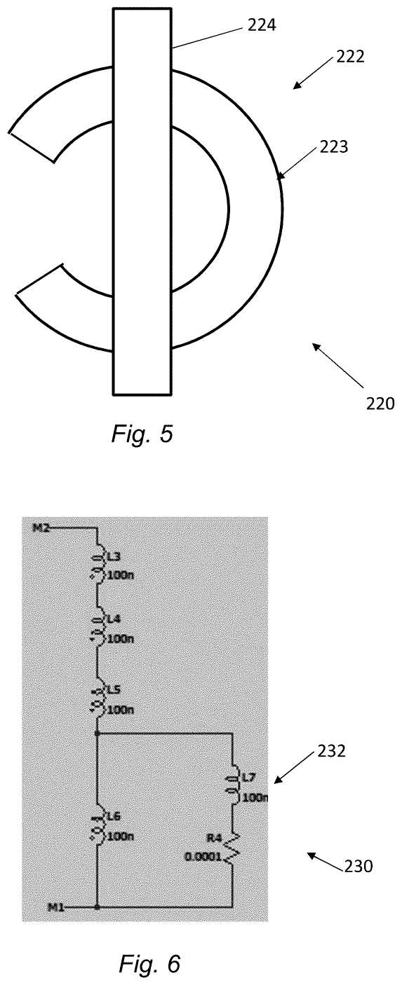

FIG. 5 is a plan view of an inductor arrangement, indicated generally by the reference numeral 220, in accordance with an example embodiment.

The inductor arrangement 220 includes an inductor 222 having one or more coils 223 that are at least partially exposed. By way of example, the inductor 222 may be implemented using the inductor 160 and the exposed coils 223 may form the portion 162 of the inductor 160. However, other arrangements are possible and will be apparent to those of ordinary skill in the art.

The inductor arrangement 220 further comprises a susceptor 224 placed across the exposed coils 223 such that the susceptor makes electrical contact with the coils exposed 223 (and hence with the inductor 222).

By way of example, the inductor 222 may be used to implement the inductor 213 of the system 210. The susceptor 224 may be the susceptor 203 of the system 200 of one of the susceptor arrangement discussed further below.

The exposed coils 223 of the inductor 222 may be resistant to corrosion; for example said coils may be gold or gold tipped.

The coils of the inductor 222 may be formed by a printed circuit board. The inductor 160 is one example implementation of such an inductor, but alternatives are possible.

FIG. 6 shows an equivalent inductor circuit, indicated generally by the reference numeral 230, in accordance with an example embodiment.

The equivalent circuit 230 comprises a series connection of inductors L3, L4, L5 and L6. The inductors L3 to L6 represent the inductance of the inductor 222. The equivalent circuit 230 further comprises a parallel connection 232 that comprises an inductor L7 and a resistor R4. The parallel connection 232 represents the susceptor 224.

The impact of placing the susceptor 224 across the exposed coils 223 of the inductor 222 is electrically represented by providing the susceptor in parallel with a part of the inductor 222. The susceptor 224 makes an electrical contact with the exposed coils that has some conceptual similarity with a voltage divider and results in inductive heating of the susceptor. The effect may be similar to that of an auto-transformer.

A susceptor (such as the susceptor 224) can make contact with exposed coils of an inductor (such as the coils 223) in many ways. By way of example, the system 1 described below provide multiple points of connection between a susceptor and exposed coils such that multiple heating zones are provided. This is one of many example implementations of the principles described herein.

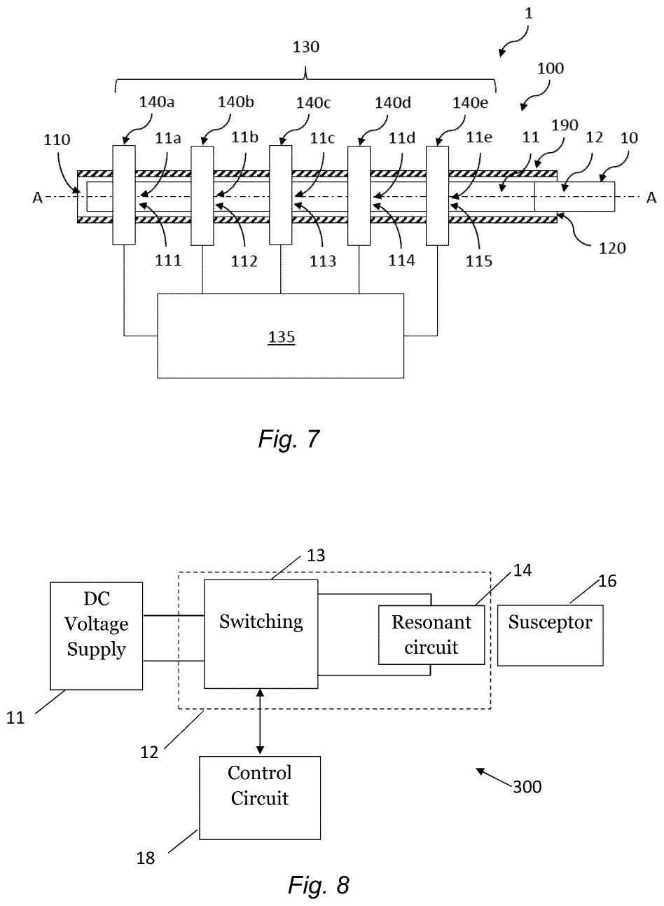

FIG. 7 is a side view of an aerosol provision system, indicated generally by the reference numeral 1, in accordance with an example embodiment. The aerosol provision system 1 may, for example, use the principles of the system 200 for heating a susceptor of an aerosol delivery device.

The system 1 comprises an aerosol provision device 100 and an article 10 comprising aerosolisable material 11. The aerosolisable material 11 may, for example, be of any of the types of aerosolisable material discussed herein. In one example, the aerosol provision device 100 is a tobacco heating product (also known in the art as a tobacco heating device or a heat-not-burn device).

The aerosol provision device 100 may therefore be configured to receive the removable article 10 in such a way that a susceptor of the article 10 makes physical and electrical contact with exposed parts of one or more coils of an inductor of the aerosol provision device 100, as described in detail above.

In some examples, the aerosolisable material 11 is a non-liquid material. In some examples, the aerosolisable material 11 is a gel. In some examples, the aerosolisable material 11 comprises tobacco. However, in other examples, the aerosolisable material 11 may consist of tobacco, may consist substantially entirely of tobacco, may comprise tobacco and aerosolisable material other than tobacco, may comprise aerosolisable material other than tobacco, or may be free from tobacco. In some examples, the aerosolisable material 11 may comprise a vapour or aerosol forming agent or a humectant, such as glycerol, propylene glycol, triacetin, or diethylene glycol. In some examples, the aerosolisable material 11 comprises reconstituted aerosolisable material, such as reconstituted tobacco.

In some examples, the aerosolisable material 11 is substantially cylindrical with a substantially circular cross section and a longitudinal axis. In other examples, the aerosolisable material 11 may have a different cross-sectional shape and/or not be elongate.

The aerosolisable material 11 of the article 10 may, for example, have an axial length of between 8 mm and 120 mm. For example, the axial length of the aerosolisable material 11 may be greater than 9 mm, or 10 mm, or 15 mm, or 20 mm. For example, the axial length of the aerosolisable material 11 may be less than 100 mm, or 75 mm, or 50 mm, or 40 mm.

In some examples, the article 10 comprises a filter arrangement 12 for filtering aerosol or vapour released from the aerosolisable material 11 in use. Alternatively, or additionally, the filter arrangement 12 may be for controlling the pressure drop over a length of the article 10. The filter arrangement 12 may comprise one, or more than one, filter. The filter arrangement 12 could be of any type used in the tobacco industry. For example, the filter may be made of cellulose acetate. In some examples, the filter arrangement 12 is substantially cylindrical with a substantially circular cross section and a longitudinal axis. In other examples, the filter arrangement 12 may have a different cross-sectional shape and/or not be elongate.

In some examples, the filter arrangement 12 abuts a longitudinal end of the aerosolisable material 11. In other examples, the filter arrangement 12 may be spaced from the aerosolisable material 11, such as by a gap and/or by one or more further components of the article 10. In some examples, the filter arrangement 12 may comprise an additive or flavour source (such as an additive- or flavour-containing capsule or thread), which may be held by a body of filtration material or between two bodies of filtration material, for example.

The article 10 may also comprise a wrapper (not shown) that is wrapped around the aerosolisable material 11 and the filter arrangement 12 to retain the filter arrangement 12 relative to the aerosolisable material 11. The wrapper may be wrapped around the aerosolisable material 11 and the filter arrangement 12 so that free ends of the wrapper overlap each other. The wrapper may form part of, or all of, a circumferential outer surface of the article 10. The wrapper could be made of any suitable material, such as paper, card, or reconstituted aerosolisable material (e.g. reconstituted tobacco). The paper may be a tipping paper that is known in the art. The wrapper may also comprise an adhesive (not shown) that adheres overlapped free ends of the wrapper to each other, to help prevent the overlapped free ends from separating. In other examples, the adhesive may be omitted or the wrapper may take a different from to that described. In other examples, the filter arrangement 12 may be retained relative to the aerosolisable material 11 by a connector other than a wrapper, such as an adhesive. In some examples, the filter arrangement 12 may be omitted.

The aerosol provision device 100 comprises a heating zone 110 for receiving at least a portion of the article 10, an outlet 120 through which aerosol is deliverable from the heating zone 110 to a user in use, and heating apparatus 130 for causing heating of the article 10 when the article 10 is at least partially located within the heating zone 110 to thereby generate the aerosol. In some examples, the aerosol is deliverable from the heating zone 110 to the user through the article 10 itself, rather than through any gap adjacent to the article 10. Nevertheless, in such examples, the aerosol still passes through the outlet 120, albeit while travelling within the article 10.

The device 100 may define at least one air inlet (not shown) that fluidly connects the heating zone 110 with an exterior of the device 100. A user may be able to inhale the volatilised component(s) of the aerosolisable material by drawing the volatilised component(s) from the heating zone 110 via the article 10. As the volatilised component(s) are removed from the heating zone 110 and the article 10, air may be drawn into the heating zone 110 via the air inlet(s) of the device 100.

In this example, the heating zone 110 extends along an axis A-A and is sized and shaped to accommodate only a portion of the article 10. In this example, the axis A-A is a central axis of the heating zone 110. Moreover, in this example, the heating zone 110 is elongate and so the axis A-A is a longitudinal axis A-A of the heating zone 110. The article 10 is insertable at least partially into the heating zone 110 via the outlet 120 and protrudes from the heating zone 110 and through the outlet 120 in use. In other examples, the heating zone 110 may be elongate or non-elongate and dimensioned to receive the whole of the article 10. In some such examples, the device 100 may include a mouthpiece that can be arranged to cover the outlet 120 and through which the aerosol can be drawn from the heating zone 110 and the article 10.

In this example, when the article 10 is at least partially located within the heating zone 110, different portions 11a-11e of the aerosolisable material 11 are located at different respective locations 111-115 in the heating zone 110. In this example, these locations 111-115 are at different respective axial positions along the axis A-A of the heating zone 110. Moreover, in this example, since the heating zone 110 is elongate, the locations 111-115 can be considered to be at different longitudinally-spaced-apart positions along the length of the heating zone 110. In this example, the article 10 can be considered to comprise five such portions 11a-11e of the aerosolisable material 11 that are located respectively at a first location 11, a second location 112, a third location 113, a fourth location 114 and a fifth location 115. More specifically, the second location 112 is fluidly located between the first location 111 and the outlet 120, the third location 113 is fluidly located between the second location 112 and the outlet 120, the fourth location 114 is fluidly located between the third location 113 and the outlet 120, and the fifth location 115 is fluidly located between the fourth location 14 and the outlet 120.

The heating apparatus 130 comprises plural heating units 140a-140e, each of which is able to cause heating of a respective one of the portions 11a-11e of the aerosolisable material 11 to a temperature sufficient to aerosolise a component thereof, when the article 10 is at least partially located within the heating zone no. The plural heating units 140a-140e may be axially-aligned with each other along the axis A-A. Each of the portions 11a-11e of the aerosolisable material 11 heatable in this way may, for example, have a length in the direction of the axis A-A of between 1 millimetre and 20 millimetres, such as between 2 millimetres and 10 millimetres, between 3 millimetres and 8 millimetres, or between 4 millimetres and 6 millimetres.

The heating apparatus 130 of this example comprises five heating units 140a-140e, namely: a first heating unit 140a, a second heating unit 140b, a third heating unit 140c, a fourth heating unit 140d and a fifth heating unit 140e. The heating units 140a-140e are at different respective axial positions along the axis A-A of the heating zone 110. Moreover, in this example, since the heating zone 110 is elongate, the heating units 140a-140e can be considered to be at different longitudinally-spaced-apart positions along the length of the heating zone no. More specifically, the second heating unit 140b is located between the first heating unit 140a and the outlet 120, the third heating unit 140c is located between the second heating unit 140b and the outlet 120, the fourth heating unit 140d is located between the third heating unit 140c and the outlet 120, and the fifth heating unit 140e is located between the fourth heating unit 140d and the outlet 120. In other examples, the heating apparatus 130 could comprise more than five heating units 140a-140e or fewer than five heating units, such as only four, only three, only two, or only one heating unit. The number of portion(s) of the aerosolisable material 11 that are heatable by the respective heating unit(s) may be correspondingly varied.

The heating apparatus 130 also comprises a controller 135 that is configured to cause operation of the heating units 140a-140e to cause the heating of the respective portions 11a-11e of the aerosolisable material 11 in use. In this example, the controller 135 is configured to cause operation of the heating units 140a-140e independently of each other, so that the respective portions 11a-11e of the aerosolisable material 11 can be heated independently. This may be desirable in order to provide progressive heating of the aerosolisable material 11 in use. Moreover, in examples in which the portions 11a-11e of the aerosolisable material 11 have different respective forms or characteristics, such as different tobacco blends and/or different applied or inherent flavours, the ability to independently heat the portions 11a-11e of the aerosolisable material 11 can enable heating of selected portions 11a-11e of the aerosolisable material 11 at different times during a session of use so as to generate aerosol that has predetermined characteristics that are time-dependent. In some examples, the heating apparatus 130 may nevertheless also be operable in one or more modes in which the controller 135 is configured to cause operation of more than one of the heating units 140a-140e, such as all of the heating units 140a-140e, at the same time during a session of use.

In this example, the heating units 140a-140e comprise respective induction heating units that are configured to generate respective varying magnetic fields, such as alternating magnetic fields. As such, the heating apparatus 130 can be considered to comprise a magnetic field generator, and the controller 135 can be considered to be apparatus that is operable to pass a varying electrical current through inductors 150 of the respective heating units 140a-140e. Moreover, in this example, the device 100 comprises a susceptor 190 that is configured so as to be heatable by penetration with the varying magnetic fields to thereby cause heating of the heating zone 110 and the article 10 therein in use. That is, portions of the susceptor 190 are heatable by penetration with the respective varying magnetic fields to thereby cause heating of the respective portions 11a-11e of the aerosolisable material 11 at the respective locations 111-115 in the heating zone 110.

In some examples, the susceptor 190 is made of, or comprises, aluminium. However, in other examples, the susceptor 190 may comprise one or more materials selected from the group consisting of: an electrically-conductive material, a magnetic material, and a magnetic electrically-conductive material. In some examples, the susceptor 190 may comprise a metal or a metal alloy. In some examples, the susceptor 190 may comprise one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze. Other material(s) may be used in other examples.

In some examples, such as those in which the susceptor 190 comprises iron, such as steel (e.g. mild steel or stainless steel) or aluminium, the susceptor 190 may comprise a coating to help avoid corrosion or oxidation of the susceptor 190 in use. Such coating may, for example, comprise nickel plating, gold plating, or a coating of a ceramic or an inert polymer.

In this example, the susceptor 190 is tubular and encircles the heating zone 110. Indeed, in this example, an inner surface of the susceptor 190 partially delimits the heating zone 110. An internal cross-sectional shape of the susceptor 190 may be circular or a different shape, such as elliptical, polygonal or irregular. In other examples, the susceptor 190 may take a different form, such as a non-tubular structure that still partially encircles the heating zone 110, or a protruding structure, such as a rod, pin or blade, that penetrates the heating zone 110. In some examples, the susceptor 190 may be replaced by plural susceptors, each of which is heatable by penetration with a respective one of the varying magnetic fields to thereby cause heating of a respective one of the portions 11a-11e of the aerosolisable material 11. Each of the plural susceptors may be tubular or take one of the other forms discussed herein for the susceptor 190, for example. In still further examples, the device 100 may be free from the susceptor 190, and the article 10 may comprise one or more susceptors that are heatable by penetration with the varying magnetic fields to thereby cause heating of the respective portions 11a-11e of the aerosolisable material 11. Each of the one or more susceptors of the article 10 may take any suitable form, such as a structure (e.g. a metallic foil, such as an aluminium foil) wrapped around or otherwise encircling the aerosolisable material 11, a structure located within the aerosolisable material 11, or a group of particles or other elements mixed with the aerosolisable material 11. In examples in which the device 100 is free from the susceptor 190, the susceptor 190 may be replaced by a heat-resistant tube that partially delimits the heating zone 110. Such a heat-resistant tube may, for example, be made from polyether ether ketone (PEEK) or a ceramic material.

In this example, the heating apparatus 130 comprises an electrical power source (not shown) and a user interface (not shown) for user-operation of the device. The electrical power source of this example is a rechargeable battery. In other examples, the electrical power source may be other than a rechargeable battery, such as a non-rechargeable battery, a capacitor, a battery-capacitor hybrid, or a connection to a mains electricity supply.

In this example, the controller 135 is electrically connected between the electrical power source and the heating units 140a-140e. In this example, the controller 135 also is electrically connected to the electrical power source. More specifically, in this example, the controller 135 is for controlling the supply of electrical power from the electrical power source to the heating units 140a-140e. In this example, the controller 135 comprises an integrated circuit (IC), such as an IC on a printed circuit board (PCB). In other examples, the controller 135 may take a different form. The controller 135 is operated in this example by user-operation of the user interface. The user interface may comprise a push-button, a toggle switch, a dial, a touchscreen, or the like. In other examples, the user interface may be remote and connected to the rest of the aerosol provision device 100 wirelessly, such as via Bluetooth.

In this example, operation of the user interface by a user causes the controller 135 to cause an alternating electrical current to pass through the inductor 150 of at least one of the respective heating units 140a-140e. This causes the inductor 150 to generate an alternating magnetic field. The inductor 150 and the susceptor 190 are suitably relatively positioned so that the varying magnetic field produced by the inductor 150 penetrates the susceptor 190. When the susceptor 190 is electrically-conductive, this penetration causes the generation of one or more eddy currents in the susceptor 190. The flow of eddy currents in the susceptor 190 against the electrical resistance of the susceptor 190 causes the susceptor 190 to be heated by Joule heating. When the susceptor 190 is magnetic, the orientation of magnetic dipoles in the susceptor 190 changes with the changing applied magnetic field, which causes heat to be generated in the susceptor 190.

The device 100 may comprise a temperature sensor (not shown) for sensing a temperature of the heating chamber 110, the susceptor 190 or the article 10. The temperature sensor may be communicatively connected to the controller 135, so that the controller 135 is able to monitor the temperature of the heating chamber 110, the susceptor 190 or the article 10, respectively, on the basis of information output by the temperature sensor. In other examples, the temperature may be sensed and monitored by measuring electrical characteristics of the system, e.g., the change in current within the heating units 140a-140e. On the basis of one or more signals received from the temperature sensor, the controller 135 may cause a characteristic of the varying or alternating electrical current to be adjusted as necessary, in order to ensure that the temperature of the heating chamber 110, the susceptor 190 or the article 10, respectively, remains within a predetermined temperature range. The characteristic may be, for example, amplitude or frequency or duty cycle. Within the predetermined temperature range, in use the aerosolisable material 11 within the article 10 located in the heating chamber 110 is heated sufficiently to volatilise at least one component of the aerosolisable material 11 without combusting the aerosolisable material 11.

Accordingly, the controller 135, and the device 100 as a whole, is arranged to heat the aerosolisable material 11 to volatilise the at least one component of the aerosolisable material 11 without combusting the aerosolisable material 11. The temperature range may be between about 50° C. and about 350° C., such as between about 100° C. and about 300° C., or between about 150° C. and about 280° C. In other examples, the temperature range may be other than one of these ranges. In some examples, the upper limit of the temperature range could be greater than 350° C. In some examples, the temperature sensor may be omitted.

In this example, the heating apparatus 130 is configured to cause heating of the first portion 11a of the aerosolisable material 11 to a temperature sufficient to aerosolise a component of the first portion 11a of the aerosolisable material 11 before or more quickly than the heating of the second portion 11b of the aerosolisable material 11 during a heating session. More specifically, the controller 135 is configured to cause operation of the first and second heating units 140a, 140b to cause the heating of the first portion 11a of the aerosolisable material 11 before or more quickly than the heating of the second portion 11b of the aerosolisable material 11 during the heating session. Accordingly, during the heating session, the position at which heat energy is applied to the aerosolisable material 11 of the article 10 is initially relatively fluidly spaced from the outlet 120 and the user, and then moves towards the outlet 120. This provides the benefit that during a heating session aerosol is generated from successive “fresh” portions of the aerosolisable material 11, which can lead to a sensorially-satisfying experience for the user that may be more similar to that had when smoking a traditional combustible factory-made cigarette.

Moreover, in some examples, the controller 135 is configured to cause a cessation in the supply of power to the first heating unit 140a, during at least part of a period (or all of the period) for which the controller 135 is configured to cause operation of the second heating unit 140b. This provides the further benefit that aerosol generated in a given portion of the aerosolisable material 11 need not pass through another portion of the aerosolisable material 11 that has previously been heated, which could otherwise negatively impact the aerosol. For example, aerosol passing through previously-heated or spent aerosolisable material can result in the aerosol picking-up components that provide the aerosol with “off-notes”.

In some examples in which the heating apparatus 130 has more than two heating units, during the heating session the heating apparatus 130 may also be configured to cause heating of at least one further portion 11b-11e of the aerosolisable material 11 to a temperature sufficient to aerosolise a component of the further portion 11b-11e of the aerosolisable material 11 before or more quickly than the heating of a still further portion 11c-11e of the aerosolisable material 11 that is fluidly closer to the outlet 120. That is, the controller 135 may be configured to cause suitable operation of the heating units to cause the heating of the at least one further portion 11b-11e of the aerosolisable material 11 before or more quickly than the heating of the still further portion 11c-11e of the aerosolisable material 11.

It will be understood that, for a given duration of heating session, the greater the number of heating units and associated portions of the aerosolisable material 11 there are, the greater the opportunity to generate aerosol from “fresh” or unspent portions of the aerosolisable material 11 extending along a given axial length. Alternatively, for a given duration of heating each portion of the aerosolisable material 11, the greater the number of heating units and associated portions of the aerosolisable material 11 there are, the longer the heating session may be. It should be appreciated that the duration for which an individual heating unit may be activated can be adjusted (e.g. shortened) to adjust (e.g. reduce) the overall heating session, and at the same time the power supplied to the heating element may be adjusted (e.g. increased) to reach the operational temperature more quickly. There may be a balance that is struck between the number of heating units (which may dictate the number of “fresh puffs”), the overall session length, and the achievable power supply (which may be dictated by the characteristics of the power source).

As discussed above, an inductor that forms part of a parallel LC resonant circuit may be used to heat a susceptor, in which the susceptor makes physical (and electrical) contact with exposed coils of the inductor. A number of other configurations are possible, as discussed further below.

FIG. 8 is a block diagram of a system, indicated generally by the reference numeral 300, in accordance with an example embodiment.

The system 300 comprises a power source in the form of a direct current (DC) voltage supply 11, a switching arrangement 13, a resonant circuit 14, a susceptor arrangement 16, and a control circuit 18. The switching arrangement 13 and the resonant circuit 14 may be coupled together in an inductive heating arrangement 12 that can be used to heat the susceptor 16.

The resonant circuit 14 may comprise a capacitor and one or more inductive elements for inductively heating the susceptor arrangement 16 to heat an aerosol generating material. Heating the aerosol generating material may thereby generate an aerosol.

The switching arrangement 13 may enable an alternating current to be generated from the DC voltage supply 11 (under the control of the control circuit 18). The alternating current may flow through the one or more inductive elements and may cause the heating of the susceptor arrangement 16. The switching arrangement may comprise a plurality of transistors. Example DC-AC converters include H-bridge or inverter circuits, examples of which are discussed below.

The system 300 has a number of similarities with the system 200 described above; however, in the system 300, the resonant circuit 14 may comprise an inductor and a capacitor connected in series, as discussed further below.

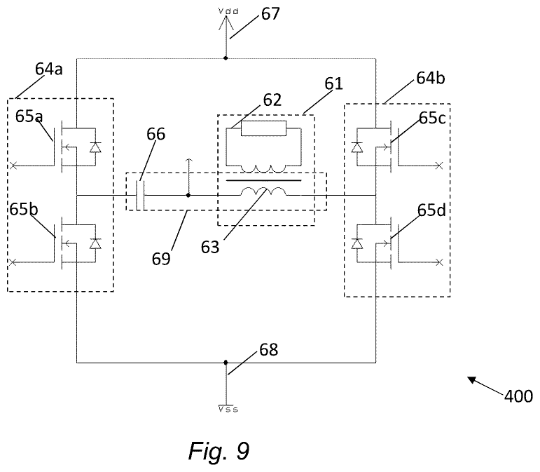

FIG. 9 is a block diagram of a circuit, indicated generally by the reference numeral 400, in accordance with an example embodiment. The circuit 400 is an example implementation of the system 300 described above.

The circuit 400 comprises a positive terminal 67 and a negative (ground) terminal 68 (that are an example implementation of the DC voltage supply 11 of the system 300 described above). The circuit 400 comprises a switching arrangement 64 (implementing the switching arrangement 13 described above), where the switching arrangement 64 comprises a bridge circuit (e.g. an H-bridge circuit, such as an FET H-bridge circuit). The switching arrangement 64 comprises a first limb 64a and a second limb 64b, where the first limb 64a and the second limb 64b are coupled by a resonant circuit 69 (which resonant circuit implements the resonant circuits 14 described above). The first limb 64a comprises switches 65a and 65b and the second limb 64b comprises switches 65c and 65d. The switches 65a, 65b, 65c, and 65d may be transistors, such as field-effect transistors (FETs), and may receive inputs from a controller, such as the control circuit 18 of the system 10.

The resonant circuit 69 comprises a series-connection of a capacitor 66 and an inductive element 63 such that the resonant circuit 69 may be an LC resonant circuit. The circuit 60 further shows a susceptor equivalent circuit 62 (thereby implementing the susceptor arrangement 16). The susceptor equivalent circuit 62 comprises a resistance and an inductive element that indicate the electrical effect of an example susceptor arrangement 16. As discussed in detail above, the susceptor 16 may be placed across (and make electrical contact with) exposed coils of the inductor 63. (Thus the susceptor 16 may be similar to the susceptor 224 described above.)

When a susceptor is present, the susceptor arrangement 62 and the inductive element 63 may act as a transformer 61 (e.g. an autotransformer). Transformer 61 may produce a varying magnetic field such that the susceptor is heated when the circuit 60 receives power. During a heating operation, in which the susceptor arrangement 16 is heated by the inductive arrangement, the switching arrangement 64 is driven (e.g., by control circuit 18) such that each of the first and second branches are coupled in turn such that an alternating current is passed through the resonant circuit 69. The resonant circuit 69 will have a resonant frequency, which is based in part on the susceptor arrangement 16, and the control circuit 18 may be configured to control the switching arrangement 64 to switch at the resonance frequency or a frequency close to the resonant frequency. Driving the switching circuit at or close to resonance helps improve efficiency and reduces the energy being lost to the switching elements (which causes unnecessary heating of the switching elements). In an example in which the article 21 comprising an aluminium foil is to be heated, the switching arrangement 64 may be driven at a frequency of around 2.5 MHz. However, in other implementations, the frequency may, for example, be anywhere between 500 kHz to 4 MHz.

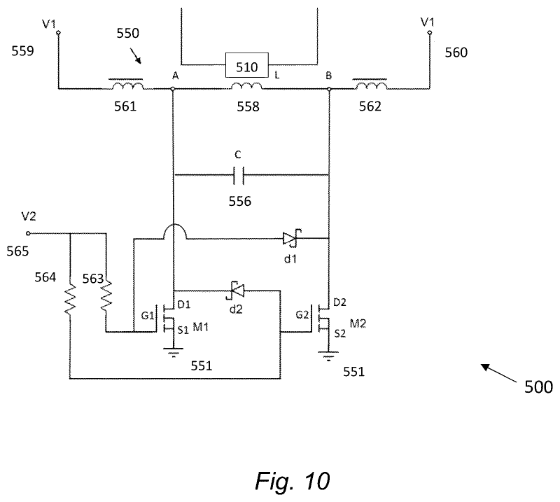

As discussed above, there are many other circuit configurations including an inductor that forms part of a parallel LC resonant circuit that may be used to heat a susceptor, in which the susceptor makes physical (and electrical) contact with exposed coils of the inductor. By way of example, FIG. 10 is a block diagram of a circuit, indicated generally by the reference numeral 500, in accordance with an example embodiment.

The circuit 500 comprises a resonant circuit 550 for inductive heating of a susceptor arrangement 510. The resonant circuit 550 comprises an inductive element 558 and a capacitor 556, connected in parallel (and is an example implementation of the resonant circuit 201 described above).

The resonant circuit 550 comprises a switching arrangement M1, M2 which, in this example, comprises a first transistor M1 and a second transistor M2. The first transistor M1 and the second transistor M2 each comprise a respective first terminal G1, G2, second terminal D1, D2 and third terminal S1, S2. The second terminals D1, D2 of the first transistor M1 and the second transistor M2 are connected to either side of the parallel inductive element 558 and the capacitor 556 combination. The third terminals S1, S2 of the first transistor M1 and the second transistor M2 are each connected to earth 151. In the circuit 500, the first transistor M1 and the second transistor M2 are both MOSFETS and the first terminals G1, G2 are gate terminals, the second terminals D1, D2 are drain terminals and the third terminals S1, S2 are source terminals. It will be appreciated that in alternative examples other types of transistors may be used in place of the MOSFETs described above.

The resonance circuit 550 has an inductance L and a capacitance C. The inductance L of the resonant circuit 550 is provided by the inductive element 558, and may also be affected by an inductance of the susceptor arrangement 510 which is arranged for inductive heating by the inductive element 558. As discussed above, in use, the susceptor arrangement 510 can be provided across (and in electrical contact with) exposed coils of the inductive element 558.

The resonant circuit 550 is supplied with a DC supply voltage V1. A positive terminal of the DC voltage supply V1 is connected to the resonant circuit 550 at a first point 559 and at a second point 560. A negative terminal (not shown) of the DC voltage supply V1 is connected to earth 551 and hence, in this example, to the source terminals S of both the MOSFETs M1 and M2. In examples, the DC supply voltage V1 may be supplied to the resonant circuit directly from a battery or via an intermediary element.

The resonant circuit 550 may therefore be considered to be connected as an electrical bridge with the inductive element 558 and the capacitor 556 in parallel connected between the two arms of the bridge. The resonant circuit 550 acts to produce a switching effect, described below, which results in a varying, e.g. alternating, current being drawn through the inductive element 558, thus creating the alternating magnetic field and heating the susceptor arrangement 510. The first point 559 is connected to a first node A located at a first side of the parallel combination of the inductive element 558 and the capacitor 556. The second point 560 is connected to a second node B, to a second side of the parallel combination of the inductive element 558 and the capacitor 556. A first choke inductor 561 is connected in series between the first point 559 and the first node A, and a second choke inductor 562 is connected in series between the second point 560 and the second node B. The first and second chokes 561 and 562 act to filter out AC frequencies from entering the circuit from the first point 559 and the second point 560 respectively but allow DC current to be drawn into and through the inductor 558. The chokes 561 and 562 allow the voltage at A and B to oscillate with little or no visible effects at the first point 559 or the second point 160.

The resonant circuit 550 switches from a first state to a second state and back again.

Thus, the resonant circuit 55 can be considered to be a self-oscillating circuit.

In the first state:
The voltage at node A is high;
The voltage at node B is low;
The first diode d1 is forward biased;
The second MOSFET M2 is ON;
The second diode d2 is reverse biased; and
The first MOSFET M1 is OFF.

From this point, with the second MOSFET M2 being in the ON state, and the first MOSFET M1 being in the OFF state, current is drawn from the supply V1 through the first choke 561 and through the inductive element 558. Due to the presence of inducting choke 561, the voltage at node A is free to oscillate. Since the inductive element 558 is in parallel with the capacitor 556, the observed voltage at node A follows that of a half sinusoidal voltage profile. The frequency of the observed voltage at node A is equal to the resonant frequency of the circuit 550.

The voltage at node A reduces sinusoidally in time from its maximum value towards 0 as a result of an energy decay at node A. The voltage at node B is held low (because MOSFET M2 is on) and the inductor L is charged from the DC supply V1. The MOSFET M2 is switched off at a point in time when the voltage at node A is equal to or below the gate threshold voltage of M2 plus the forward bias voltage of d2. When the voltage at node A has finally reached zero, the MOSFET M2 will be fully off.

At the same time, or shortly after, the voltage at node B is taken high. This happens due to the resonant transfer of energy between the inductive element 558 and the capacitor 556. When the voltage at node B becomes high due to this resonant transfer of energy, the situation described above with respect to the nodes A and B and the MOSFETs M1 and M2 is reversed. That is, as the voltage at A reduces towards zero, the drain voltage of M1 is reduced. The drain voltage of M1 reduces to a point where the second diode d2 is no longer reverse biased and becomes forward biased. Similarly, the voltage at node B rises to its maximum and the first diode d1 switches from being forward biased to being reverse biased. As this happens, the gate voltage of M1 is no longer coupled to the drain voltage of M2 and the gate voltage of M1 therefore becomes high, under the application of gate supply voltage V2. The first MOSFET M1 is therefore switched to the ON state, since its gate-source voltage is now above the threshold for switch-on. As the gate terminal of M2 is now connected via the forward biased second diode d2 to the low voltage drain terminal of M1, the gate voltage of M2 is low. M2 is therefore switched to the OFF state.

In summary, at this point the circuit 150 is in a second state, wherein:
The voltage at node A is low;
The voltage at node B is high;
The first diode d1 is reverse biased;
The second MOSFET M2 is OFF;
The second diode d2 is forward biased; and
The first MOSFET M1 is ON.

At this point, current is drawn through the inductive element 558 from the supply voltage V1 through the second choke 562. The direction of the current has therefore reversed due to the switching operation of the resonant circuit 550. The resonant circuit 550 will continue to switch between the first state and the second state.

In the steady state of operation, energy is transferred between the electrostatic domain (i.e., in the capacitor 556) and the magnetic domain (i.e., the inductor 558), and vice versa.

The resonant frequency of the circuit 550 is dependent on the inductance L and capacitance C of the circuit 550, as set out above, which in turn is dependent on the inductive element 558, capacitor 556 and additionally the susceptor arrangement 510. That is, it can be considered that the resonant frequency changes in response to energy being transferred from the inductive element to the susceptor arrangement.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An apparatus comprising:
a resonant circuit comprising an inductive element and a capacitor, wherein the inductive element comprises one or more coils that are at least partially exposed, wherein said inductive element is for heating a susceptor when said susceptor is placed across, and makes electrical contact with, said exposed coils; and
a circuit for applying one or more pulses to said resonant circuit.

2. An apparatus as claimed in claim 1, wherein the exposed coils of the inductive element are resistant to corrosion.

3. An apparatus as claimed in claim 1, wherein said coils are gold or gold tipped.

4. An apparatus as claimed in claim 1, wherein the one or more coils of the inductive element are formed by a printed circuit board.

5. An apparatus as claimed in claim 4, wherein printed circuit board is a multi-layer printed circuit board and said coils are formed from different layers of said printed circuit board.

6. An apparatus as claimed in claim 1, wherein the inductive element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion.

7. An apparatus as claimed in claim 6, wherein the first portion is a first partial annulus and the second portion is a second partial annulus.

8. An apparatus as claimed in claim 1, wherein the inductive element and the capacitor are connected in parallel.

9. An apparatus as claimed in claim 1, wherein the inductive element and the capacitor are connected in series.

10. An apparatus as claimed in claim 1, wherein said circuit is a self-oscillating driving circuit.

11. An apparatus as claimed in claim 1, wherein said circuit includes an H-bridge driving circuit.

12. A delivery system comprising an apparatus as claimed in claim 1.

13. A delivery system as claimed in claim 12, configured to receive a removable article comprising an aerosol generating material.

14. A delivery system as claimed in claim 13, wherein said aerosol generating material comprises an aerosol generating substrate and an aerosol forming material.

15. A delivery system as claimed in claim 13, wherein said removable article includes a susceptor arrangement.

16. A delivery system as claimed in claim 15, wherein, in use, the susceptor arrangement makes electrical contact with the one or more at least partially exposed coils of the inductive element of the apparatus.

17. A delivery system as claimed in claim 12, wherein the delivery system is a non-combustible aerosol generating device.
